(19) United States
(12) Patent Application Publication
(10) Pub. No.: US 2025/0168549 A1
(43) Pub. Date: May 22, 2025

(54) EARBUD CHARGING CRADLE AND EARBUD CONNECTION METHOD USING SAME

(71) Applicant: LG ELECTRONICS INC., Seoul (KR)

(72) Inventors: Minwoo KIM, Seoul (KR); Youngwook KIM, Seoul (KR)

(73) Assignee: LG ELECTRONICS INC., Seoul (KR)

(21) Appl. No.: 18/836,592

(22) PCT Filed: Feb. 8, 2022
(86) PCT No.: PCT/KR2022/001922

§ 371 Date: Aug. 7, 2024

(51) Int. Cl. H04R 1/10; H02J 7/00

(52) U.S. Cl. CPC H04R 1/1025; H02J 7/0044; H02J 7/0047; H04R 1/1016

(57) ABSTRACT

Provided is an earbud charging cradle configured to receive an earbud capable of wireless communication and charge the earbud. The earbud charging cradle can include a placement unit configured to accommodate the earbud, and configured to charge the earbud, a sensing unit configured to sense placement of the earbud on the placement unit, a communication unit configured to perform communication with the earbud placed on the placement unit, an input unit configured to receive a user's input, an output unit configured to output an alert associated with a connected device, and a processor configured to execute a connection mode that controls a connection to a device when the placement of the earbud on the placement unit is sensed by the sensing unit.

### TECHNICAL FIELD

The present disclosure relates to an earbud charging cradle and an earbud connection method that uses the earbud charging cradle and, more specifically, to a charging cradle capable of making an earbud to a device while the earbud is placed for charging and an earbud connection method that uses the charging cradle.

### BACKGROUND ART

In recent years, there has been an increasing demand for portable audio devices that comply with wireless communication schemes in terms of mobility and user convenience. A wireless earbud excellent in flexibility among audio devices is charged by coming into contact with, and connecting to, a power circuit through Pogo pins or terminals mounted on a charging cradle.

With a continuous increase in the number of users of these wireless earbuds, there has been an increase in the number of multi-device user scenes that are used in conjunction with personal multimedia devices, such as tablets, wearable devices, and smart TVs or devices supporting Bluetooth®, such as home appliances.

However, interfaces associated with inputs and information display are provided to current earbuds in a limited manner due to issues such as size and power consumption. These earbuds are only passive connection control targets, and entities responsible for connection control are the counterpart devices. Accordingly, the counterpart devices need to inconveniently perform operations associated with the earbuds, and the limitation of the earbuds is that the usability thereof in the multi-device user scenes is significantly low.

### DISCLOSURE OF INVENTION

### Technical Problem

Objects of the present disclosure are to address the above-mentioned problems and other problems.

One object of embodiments of the present disclosure is to provide a charging cradle capable of controlling a connection of an earbud in a quicker and more intuitive manner using the charging cradle that is always carried by a user, without requiring an operation on the counterpart device, and an earbud connection method that uses the charging cradle.

Another object of the embodiments of the present disclosure is to provide a charging cradle that is embodied in such a manner as to control a connection of an earbud to a device using the earbud placed on the charging cradle, and an earbud connection method that uses the charging cradle.

A further object of the embodiments of the present disclosure is to provide a charging cradle capable of identifying a device currently connected to an earbud through the charging cradle and of making a connection to a new device through a placed earbud and externally displaying information about the connected device, and an earbud connection method that uses the charging cradle.

Still another object of the embodiments of the present disclosure is to provide a charging cradle that is embodied in such a manner as to perform various control functions that are further expanded, as well as device connection control, using mutual wireless communication between a pair of earbuds while one earbud is placed and the other earbud is worn and used, and an earbud connection method that uses the charging cradle.

### Solution to Problem

To this end, an earbud charging cradle according to the present disclosure may be embodied in such a manner as to sense placement of an earbud on the main body thereof, to make a connection to a device a connection to which is desired, using the placed earbud, and to output alert information indicating the connected device.

The charging cradle transmits to the placed earbud a control signal for connection and enables the placed earbud to transmit a wireless signal for a connection to a device matched to index information contained in a control signal.

According to one aspect of the present disclosure, there is provided a charging cradle on which an earbud is placed and charged, the charging cradle including: a placement unit accommodating an earbud capable of wireless communication, for charging; a sensing unit configured to sense placement of the earbud on the placement unit; a communication unit configured to perform communication with the earbud placed on the placement unit; an input unit configured to receive a user's input; an output unit configured to output an alert associated with a connected device; and a processor configured to execute a connection mode that controls a connection to a device when the placement of the earbud on the placement unit is sensed. In the earbud charging cradle, during the connection mode, the processor transmits to the earbud a control signal for connecting the earbud to a matched device corresponding to an input received in the input unit, and, in response to the connection of the earbud to the matched device through the earbud, outputs to the output unit an alert signal indicating a connected state of the earbud, which contains information about the connected device.

In the earbud charging cradle, the matched device corresponding to the received input may be selected from among index-assigned devices that are among connection-target devices registered with the earbud.

In the earbud charging cradle, the received input may correspond to a touch input applied to an input module included in the input unit or successive touch inputs, the index may vary, in a rotating manner, with an increase in the number of times of the touch input, and a device connected to the selected index may be selected as the matched device.

In the earbud charging cradle, the received input may correspond to any one of a plurality of different inputs that are applied to an input module included in the input unit, different indexes may be mapped to the plurality of different inputs, respectively, and any one of the devices connected to the indexes, respectively, may be selected as the matched device.

In the earbud charging cradle, during the connection mode, in response to reception of a first input in a state where the earbud is connected to a first device, the processor may transmit to the earbud a first control signal for making a disconnection from the first device and a second control signal for making a connection to a second device matched to the first input.

In the earbud charging cradle, the output unit may include a plurality of LED modules, and, in response to the connection of the earbud to the matched device through the earbud, the processor may control a first LED module to be in a turned-on state and may control the output unit in such a manner as to output a display indicating the connected matched device while the first LED module is in the turned-on state.

In the earbud charging cradle, in response to the transmission of the control signal for connecting the earbud to the matched device to the earbud, the processor may control a second LED module to be in a turned-in state and may control the output unit in such a manner as to display a display indicating the matched device to which a connection is being attempted, while the second LED is in the turned-on state.

In the earbud charging cradle, a display indicating the matched device, which is output to the first and second LED modules, may be a color-designated display indicating an index assigned to the matched device.

In the earbud charging cradle, when a currently connected device is detected as being present at a point in time when the earbud is sensed as being placed on the placement unit, the processor may control the first LED module to be in the turned-on state and may transmit a signal to the output unit in such a manner that a designated color indicating an index assigned to the currently connected device is displayed on the first LED module.

In the earbud charging cradle, the sensing unit may include a plurality of sensors for sensing the placement of a pair of the earbuds, respectively, that are capable of wirelessly communicating with each other, and, in a case where placement of a first earbud is sensed through a first sensor and where placement of a second earbud is not sensed through a second sensor, during the connection mode, the processor may perform control in such a manner that a control signal for making a connection to the matched device corresponding to the input received in the input unit is transmitted from the first earbud to the second earbud and that, in response to the connection to the matched device through the second earbud, the alert signal is output based on a connection response signal received in the first earbud from the second earbud.

In the earbud charging cradle, in a state where placement of a first earbud is sensed through a first sensor and where a second earbud is connected to the matched device without placement of a second earbud being sensed, in response to reception of an input for functional control, which is received in the input unit, the processor may enable a functional control signal, corresponding to the received input, to be transmitted from the first earbud to the second earbud and may enable the second earbud and the matched device to perform operations, respectively, that correspond to the functional control signal.

According to another aspect of the present disclosure, there is provided an earbud connection method that uses a cradle on which an earbud is placed and charged, the earbud connection method including: a step of sensing placement of an earbud on the cradle; a step of executing a connection mode that controls a connection to a device; a step of transmitting to the earbud a control signal for connecting the earbud to a matched device corresponding to an input received in the cradle; and a step of outputting an alert signal indicating a connected state of the earbud, which contains information about the connected device, in response to the connection of the earbud to the matched device through the earbud.

The earbud connection method, after the step of transmitting to the earbud the control signal, may further include a step of enabling a first LED module included in the cradle to be in a turned-on state and displaying on the first LED module a color indicating an index corresponding to the matched device a connection to which is intended, in response to the transmission of the control signal for connecting the earbud to the matched device to the earbud.

In the earbud connection method, the step of outputting the alert signal may include a step of enabling a second LED module, different from the first LED module, which is included in the cradle, to be in a turned-on state and displaying on the second LED module a color indicating an index corresponding to the connected matched device, in response to the transmission of the control signal for connecting the earbud to the matched device to the earbud through the earbud.

In the earbud connection method, the step of sensing the placement of the earbud may be a step of sensing through a first sensor that a first earbud is placed and sensing through a second sensor that a second earbud is not placed, and the step of transmitting to the earbud the control signal may include a step of making a connection to the matched device through the second earbud by transmitting the control signal from the first earbud to the second earbud.

According to a further aspect of the present disclosure, there is provided an earbud connection system including: a pair of earbuds providing associated audio by performing wireless communication with a device; and a charging cradle on which the earbud is placed and charged. In the earbud connection system, the charging cradle executes a connection mode that controls a connection to the device when the placement of the earbud is sensed, and transmits to the earbud a control signal for connecting a wireless earbud to a matched device corresponding to a received input. In the earbud connection system, the earbud transmits to the matched device a connection signal corresponding to the control signal, makes a connection based on a response signal received from the matched device, transmits to the cradle a signal corresponding to making the connection, and outputs an alert signal indicating a connected state of the earbud, which contains information about a device to which the charging cradle is connected.

### Advantageous Effects of Invention

Effects of a digital signage platform providing device, an operation method thereof, and a system including the digital signage platform providing device are described as follows.

According to embodiments of the present disclosure, a connection of an earbud can be controlled in a faster and more intuitive manner using a charging cradle that is always carried by a user, without requiring an operation on the earbud, where erroneous operations occur frequently, or the counterpart device.

According to the embodiments of the present disclosure, a device that is currently connected to the earbud can be quickly checked through the charging cradle, and a connected state of a newly connected device and information about the connected device can be intuitively recognized through the placed earbud.

According to the embodiments of the present disclosure, various control functions that are further expanded, as well as device connection control, can be performed using mutual wireless communication between a pair of earbuds while one earbud is placed and the other earbud is worn and used.

### BRIEF DESCRIPTION OF DRAWINGS

FIG. 1 is a view illustrating a charging cradle on which earbuds according to an embodiment of the present disclosure are placed.

FIG. 2 is a block diagram illustrating the earbuds and a detailed configuration of the charging cradle according to the embodiment of the present disclosure, and illustrating devices a connection to which is intended.

FIG. 3 is a representative flowchart that is referenced to describe an earbud connection method that uses the charging cradle according to the embodiment of the present disclosure.

FIG. 4 is a flowchart that is referenced to describe a method of changing a device to which the earbud makes a connection using the charging cradle according to the embodiment of the present disclosure.

FIGS. 5, 6, and 7 are views illustrating examples, respectively, of an alert output associated with the connection between the earbud and the device in the charging cradle according to the embodiment of the present disclosure.

FIG. 8 is a view illustrating the charging cradle on which only one of a pair of the earbuds according to the embodiment of the present disclosure is placed.

FIG. 9 is a flowchart that is referenced to describe operations that are performable in a state where only one earbud is placed on the charging cradle according to the embodiment of the present disclosure.

FIG. 10 is a flowchart that is referenced to describe a method of assigning an index to the device in the earbud according to the embodiment of the present disclosure.

### MODE FOR THE INVENTION

Description will now be given in detail according to exemplary implementations disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms “include” or “has” used herein should be understood that they are intended to indicate the existence of a feature, a number, a step, an element, a component or a combination thereof disclosed in the specification, and it may also be understood that the existence or additional possibility of one or more other features, numbers, steps, elements, components or combinations thereof are not excluded in advance.

An ‘earbud’ disclosed in the present specification refers to a wireless earbud fitted directly into the outer part of a user's ear, which wirelessly connects to a device and outputs audio. Unless otherwise specified, an ‘earbud’ refers to a pair of earbuds that are fitted directly into the outer parts, respectively, of the user's ears.

In addition, a ‘first earbud’ and a ‘second earbud’ disclosed in the present specification are not limited to a specific wearing direction such as the left or right direction. For example, the first earbud may refer to a left or right earbud, and the second earbud may refer to a right or left earbud.

Examples of a ‘device’ disclosed in the present specification may include all types of devices and home appliances that are capable of being paired with an earbud and outputting audio. In addition, in association with connection control of the earbud, unless otherwise specified, the ‘device’ refers to a device that has been paired at least once with the earbud and is registered therewith.

A method is proposed below in which the earbud is sensed as being placed on a charging cradle according to the present disclosure. In this method, a connection is quickly made to a device to which a connection is desired, using the placed earbud, and information indicating the connected device is immediately provided.

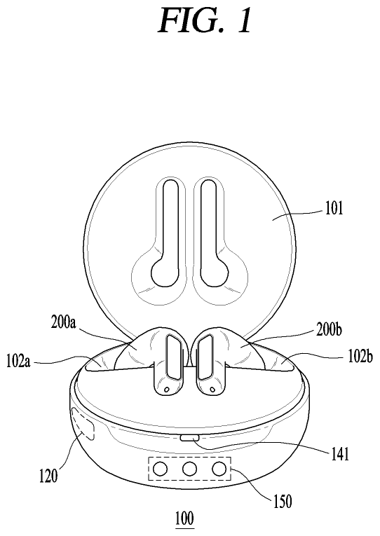

FIG. 1 is a view illustrating a charging cradle on which earbuds according to an embodiment of the present disclosure are placed.

Referring to FIG. 1, the exterior appearance of a charging cradle 100 according to the present disclosure may be formed as rounded but is not limited to this shape. An internal space where the earbud can be accommodated is formed inside the charging cradle 100.

The outside of a cover 101 of the charging cradle 100 forms a housing of the charging cradle 100, and the inside of the cover 101 thereof forms a hollow (empty space) corresponding to the shape of the earbud accommodated within the internal space in the charging cradle 100.

The charging cradle 100 may accommodate a pair of earbuds, for example, a first earbud 200a and a second earbud 200b. The first earbud 200a and the second earbud 200b are charged by coming into contact with, and connecting to, a power/charging circuit (not illustrated) through Pogo pins or terminals.

The charging cradle 100 includes the cover 101 on the outside. The cover 101 is openable and closable. The charging cradle 100 includes first and second placement units 102a and 102b on the inside. The first earbud 200a and the second earbud 200b correspond to the first and second placement units 102a and 102b, respectively, in such a manner as to be accommodated and charged.

The first and second placement units 102a and 102b may include sensors (which may be referred to as “earbud switches”) for sensing the placement of the first earbud 200a and the second earbud 200b, respectively. Through a plurality of earbud switches, the charging cradle 100 may sense in a distinguishing manner whether or not the first earbud 200a is placed and whether or not the second earbud 200b is placed.

The housing and the cover 101 of the charging cradle 100 may be manufactured from, for example, plastic, stainless steel, aluminum, or from arbitrary other materials. A pair of the placement units 102a and 102b inside the charging cradle 100 that accommodates the earbuds 200a and 200b may be manufactured from silicone or similar materials.

The charging cradle 100 includes an input unit 120 on one side. The input unit 120 may receive the user's input. The input unit 120 may be embodied as a physical user interface PUI, for example, such as a hard/soft button, a touch sensor, or a force sensor.

The charging cradle 100 may include an output unit 150 on one side. The output unit 150 serves to display information associated with earbud charging and information associated with earbud connection control. The output unit 150 may be embodied as a plurality of LED modules. FIG. 1 illustrates that three LED modules are provided side by side, but two or fewer LED modules or four or more LED modules may also be provided.

A processor (not illustrated) of the charging cradle 100 may transfer signals associated with the earbud's connection attempt, connection state, connection termination, and the like to the output unit 150. Based on the received signal, the output unit 150 may display a connected state of the earbud and information about a connected device by varying lighting and non-lighting states, lighting colors, and lighting positions of the plurality of LED modules provided.

The charging cradle 100 may include one or more circuits (not illustrated) inside and may communicate with the earbuds 200a and 200b, and/or may include an interface (hereinafter referred to as a ‘first interface’) through which the earbuds 200a and 200b can be charged. In addition, the charging cradle 100 may include an interface (hereinafter referred to as a ‘second interface’) for providing

AC or DC power to the earbuds 200a and 200b or providing wired or wireless power to the earbuds 200a and 200b through an inductive charging pad.

The charging cradle 100 may include a fastening member (not illustrated) that supports the cover 101 in such a manner as to rotate in one preset direction.

The charging cradle 100 may include a sensor 141, for example, a magnet and Hall sensor, on the portion that comes into contact with the main body in a state where the cover 101 is closed. The sensor 141 senses the opening and closing of the cover 101. The charging cradle 100 may detect the opening (uncovering) or closing of the cover 101 through the sensor 141. When switching from a closed state to an open state, the charging cradle 100 may perform a preset operation associated with pairing (an operation of pairing with the last device that was paired or a device that is positioned nearby).

The placement units 102a and 102b which are provided inside the charging cradle 100 and in which the earbuds 200a and 200b, respectively, are accommodated, may include respective magnetic components (for example, magnets) (not illustrated) inside. The magnetic components serve to easily attract the earbuds 200a and 200b and to support the accommodation thereof.

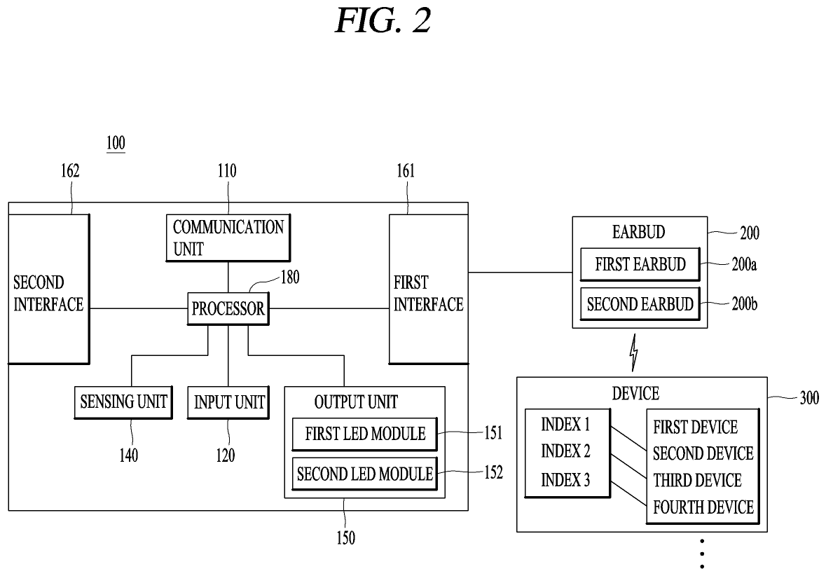

FIG. 2 is a block diagram illustrating the earbuds and a detailed configuration of the charging cradle according to the embodiment of the present disclosure, and illustrating devices a connection to which is intended.

The charging cradle 100 according to the present disclosure may include a communication unit 110, the input unit 120, a sensing unit 140, the output unit 150, first and second interfaces 161 and 162, and a processor 180. The output unit 150 may include at least a first LED module 151 and a second LED module 152.

The communication unit 110 may include a communication module for communicating with the earbud 200 placed on the charging cradle 100.

The communication unit 110 may transmit a signal for initiating a pairing sequence between the earbud 200 and the device connected to the earbud 200 through the earbud 200 placed on the charging cradle 100. The communication unit 110 may be used as a transmission path for downloading a sound source or similar content from the device connected to the earbud 200 and storing the downloaded sound source or similar content. In addition, the communication unit 110 may include one or more circuits inside and may communicate with the earbud 200 and/or may substitute for the first interface 161 through the earbud 200 can be charged.

Examples of the input unit 120 may include input modules, such as one or more hard/soft buttons, a touch sensor, and a force sensor. The input modules serve to receive the user's input. The input unit 120 receives various types of the user's inputs and transfers a signal, corresponding to the received input, to the processor 180. The processor 180 performs a corresponding operation. In addition, the input unit 120 may include a voice reception unit (for example, a microphone) (not illustrated) for receiving the user's voice.

According to the embodiment of the present disclosure, when a signal corresponding to the input received in the input unit 120 is transferred to the processor 180, the processor 180 generates a control signal for connecting the earbud to a device, matched to the received signal. The processor 180 transmits the generated control signal to the placed earbud 200 through the first interface 161, thereby making a connection to the device through the earbud 200.

The sensing unit 140 may include a plurality of sensors for sensing whether or not the earbuds 200a and 200b are placed on the placement units, respectively, of the charging cradles. Specifically, a sensor for sensing the placement of the first earbud 200a may be provided on the first placement unit 102a, and a sensor for sensing the placement of the second earbud 200b may be provided on the second placement unit 102b. Each of the sensors may generate an individual detection signal and may transfer the generated individual detection signal to the processor 180.

The sensing unit 140 may include a magnetic sensor, an optical sensor, a switch, a Hall effect sensor, a magnetic flux sensor, a capacitive sensor, an optical detector, a proximity detector, a momentary switch, or an arbitrary different type of sensor in order to sense the placement of the earbuds 200a and 200b. In an embodiment, the different type of sensor may refer to a circuit that pings, at predetermined time intervals, contact units (for example, Pogo pins or the like) that are provided on the placement units 102a and 102b, respectively, that constitute a pair.

Through the sensing unit 140, the processor 180 may recognize in a distinguishing manner whether or not the earbud 200 is placed on each of the pair of the placement units 102a and 102b, or whether or not the earbud 200 is placed on only one of the pair of the placement units 102a and 102b. In response to the placement of the earbud 200 on at least one placement unit, the processor 180 may execute a connection mode for controlling device connection.

In addition, the sensing unit 140 may include a sensor for sensing whether or not the cover 101 (in FIG. 1) of the charging cradle 100 is open, and a sensor for sensing a surrounding environment of the charging cradle 100 and an object.

For example, the sensing unit 140 may further include a proximity sensor, an illumination sensor, a touch sensor, an acceleration sensor, a magnetic sensor, a G-sensor, a gyroscope sensor, a motion sensor, a RGB sensor, an infrared (IR) sensor, a battery gauge, and an environmental sensor (for example, a thermometer, a radioactivity detection sensor, a thermal detection sensor, a gas detection sensor, or the like).

The output unit 150 may include indicator units, for example, the first LED module 151 and the second LED module 152, for displaying an attempt to make a connection to a device, which is made through the earbud 200 placed on the charging cradle 100, a connected state of the device, and information about the connected device.

In an embodiment, the first LED module 151 may display a connected state and information about a connected device through lighting and a color (for example, R, G, or B), and the second LED module 152 may display a connection attempt through lighting and a color (for example, R, G, or B).

In another embodiment, the lighting of the first LED module 151 may indicate a state of a connection to a first device to which an index (for example, Index 1) matched to the first LED module 151 is assigned, and the lighting of the second LED module 152 may indicate a state of a connection to a second device to which an index (for example, Index 2) matched to the second LED module 152 is assigned.

In a case where the output unit 150 includes a display module, an attempt by the placed earbud 200 to make a connection to a device, a connected state of the device, and information about the connected state may be displayed, in the form of specific numbers, text, and symbols, on the display module.

In a case where the output unit 150 includes an audio output unit (for example, a speaker), an attempt by the placed earbud 200 to make a connection to a device, a connected state of the device, and information about the connected state may be output in the form of preset voice signals, sound, and voice.

The output unit 150 may include indication units, for example, three or four LED modules for indicating the remaining battery amount in the charging cradle 100 and/or a battery charging level of at least one of the placed earbuds 200a and 200b.

The processor 180 may perform overall control of operations of constituent elements of the charging cradle.

Specifically, the processor 180 may detect whether or not the earbuds 200 in a pair are individually placed, based on a signal transferred through the sensing unit 140.

Based on the input received in the input unit 120, the processor 180 may recognize a device a connection to which is desired, more specifically, an index-assigned device which is matched to the received input, and may transmit a control signal for connecting the earbud to the device, to the placed earbud through the first interface 161.

The processor 180 may receive information about a device connected to the earbud 200, from the placed earbud through the first interface 161 and may control the output unit 150 in such a manner as to output the connected state and the information about the connected device, for example, indicators.

Through the first interface 161, communication with the placed earbud 200 can be performed, and/or the placed earbud 200 can be charged. To this end, the first interface 161 may be connected to a circuit (no illustrated) for communication and a circuit (not illustrated) for power supply, which are provided inside the charging cradle 100.

The second interface 162 may include a power circuit for supply power to the charging cradle. The second interface 162 may be a portion of a micro-USB connector, a lighting connector, or a receptacle connector that provides power to the charging cradle 100. Power provided through the second interface 162 is used to charge the placed earbud 200 through the first interface 161. In an embodiment, the second interface 162 may further include a wireless power receiver, such as one or more wireless power coils, for receiving induced power from a power source (not illustrated).

Although not illustrated, the charging cradle 100 may further include a memory (not illustrated) for storing commands, which support various functions, sound sources, and the like. For example, the charging cradle 100 may download sound sources or the like from a device 300 connected to the earbud 200, through the earbud 200, and may store the downloaded sound sources and the like.

The memory (not illustrated) may be, for example, at least one of the following types of storage media: a flash memory type, a hard disk type, a solid-state disk (SSD) type, a silicon disk drive (SDD) type, a multimedia card micro type, a card type memory (for example, an SD or XD memory type, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, or the like.

The earbud 200 may include a pair of earbuds, that is, the first and second earbuds 200a and 200b,

When placed on the charging cradle 100, through the first interface 161, the earbud 200 may perform communication with the charging cradle 100 and/or be supplied with power. In this case, a circuit (communication circuit) necessary for the placed earbud 200 and the charging cradle 100 to perform communication, and a circuit (power circuit) necessary for the placed earbud 200 to be supplied with power from the charging cradle 100 may each be provided inside the charging cradle 100.

Through the sensing unit 140, the charging cradle 100 may detect whether or not the earbud is placed on the first placement unit 102a and/or whether or not the earbud is placed on the second placement unit 102b and may perform corresponding operations. For example, when the earbud is detected as being placed on only one of the pair of the placement units 102a and 102b, the processor 180 of the charging cradle 100 may perform control in such a manner that charging power is supplied to only the corresponding earbud (through the power circuit).

The device 300 may be connected to the earbud 200 and may perform wireless communication, for example, short-range wireless communication.

Examples of short-range communication schemes include Bluetooth™ Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB). At least one of these technologies may apply to wireless communication between the device 300 and earbud 200.

A plurality of devices 300, a connection to each of which is possible, may be registered with the earbud 200. According to the embodiment of the present disclosure, the earbud 200 placed on the charging cradle 100 may be selectively connected to some index-assigned devices (for example, devices 2, 3, and 4 in FIG. 2) that are among the registered devices.

An internal processor component, an input module, an output module, and a wireless communication module may be included in each of the earbuds 200a and 200b.

The wireless communication module may enable an audio signal to be received from the connected device 300, using a low power communication protocol (for example, Bluetooth®, low-power Bluetooth®, or ZigBee), and may transmit to the connected device 300 commands for performing one or more functions, such as connecting and disconnecting a call, pausing audio playback, fast-forwarding, rewinding, and muting an audio signal.

The input module may be one or more buttons or a sensor. For example, an accelerometer or a capacitive sensor may be used as the input module. The input module may transmit to the processor component a signal for engaging a pairing mode, based on the received input.

The internal processor component may be coupled to one or more speakers, microphones, and chargeable batteries and one or more circuit units and may generate commands for performing various operations of the earbud.

The output module may include an audio output module for outputting an audio signal through a speaker and an optical module for displaying LED light or the like. Through lighting and non-lighting states, a lighting color, and the like, the LED light may display an alert signal (for example, an incoming call) associated with the connected device 300, a battery charging level, pairing mode engagement, and other functions.

The charging cradle 100 disclosed below in the present specification embodies a method of controlling a connection between an earbud and a device and a method of displaying connection-associated information, using at least one earbud placed inside the charging cradle 100. Moreover, the charging cradle 100 disclosed in the present specification embodies a method of controlling various functions associated with a connected device, using only one placed earbud.

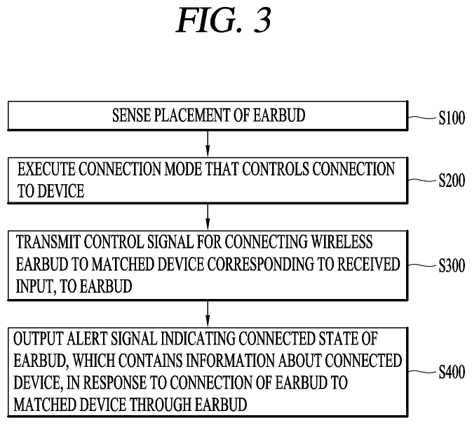

FIG. 3 is a representative flowchart that is referenced to describe an earbud connection method that uses the charging cradle 100 according to the embodiment of the present disclosure.

The charging cradle 100 is formed to sense the placement of the earbuds 200a and 200b on the placement units 200a and 200b, respectively, in a pair in which the earbud 200 is accommodated and is charged. The placed earbuds 200a and 200b may be supplied with power through the power circuit (not illustrated) of the charging cradle 100 and may perform data communication through the communication circuit (not illustrated). The earbuds 200a and 200b each are capable of performing wireless communication with each other and are capable of performing wireless communication for making a connection to and making a disconnection from any one of the devices 300 registered with the earbud 200 and for performing at least one function.

The earbud connection method illustrated in FIG. 3 first starts with a step of sensing, by the charging cradle 100 according to the present disclosure, the placement of the earbud on the cradle through the sensing unit (S100). More specifically, the processor 180 of the charging cradle 100 may receive a detection signal received from a sensor for sensing the placement of the first earbud 200a and/or a detection signal received from a sensor for sensing the placement of the second earbud 200b and thus may detect whether or not the individual earbud is placed.

Next, in response to the placement of at least one earbud, the processor 180 of the charging cradle 100 executes the connection mode for connecting the earbud 200 to the device 300 (S200).

The connection mode may include a signal that indicates the presence of the device connected to the placed earbud 200.

After the earbud 200 is sensed as being placed, the connection mode may be executed in response to the elapse of a predetermined time (for example, one to two seconds) or the reception of a preset input (for example, a single touch on the input module of the input unit 120). In this case, a signal (for example, signal sound, turning-on or flickering of an LED module, or the like) indicating that the connection mode is executed may be output.

In an embodiment, in a case where the device already connected to the placed earbud is present, alert information indicating the presence of a currently connected device may be output through the output unit 150 of the charging cradle 100. The alert information here may be any one of visual information or audio information.

In a case where the alert information is visual information, for example, a currently connected device may be indicated using any one of a lighting pattern, a lighting position, or a lighting color of an LED module included in the charging cradle, or using any one of a form image, a symbol, a number, or text that is displayed on the display module included in the charging cradle. For example, in a case where the earbud is connected to a device A, information that not only indicates the presence of a connected device but also indicates the connected device A, for example, an LED color corresponding to an index allocated (assigned) to the device A may be displayed.

In a case where the alert information is audio information, for example, a currently connected device may be indicated in the form of any one of signal sound, a sound pattern, or voice that is output through the audio output module (for example, the speaker) included in the charging cradle.

At the same time as the connection mode is executed, the charging cradle 100 according to the present disclosure performs charging by supplying power to the placed earbud, through the power circuit (not illustrated) included inside the charging cradle. At this time, the charging cradle 100 may sequentially output an alert signal associated with the connection mode and an alert signal (for example, a charging start signal, the extent of charging, a charging level, and the like) associated with the charging through the output unit 150. In addition, the charging cradle 100 may also display an alert signal associated with the connection mode and an alert signal (for example, a charging start signal, the extent of charging, a charging level, and the like) associated with the charging at the same time on different output modules inside the output unit 150.

Consequently, the earbud charging cradle 100 may transmit to the earbud a control signal for connecting the earbud to a matched device corresponding to the input received through the input unit 120 (S300).

Specifically, the charging cradle 100 may receive the user's input through the input unit 120, for example, through the physical interface (PUI), such as a hard/soft button, a touch sensor, or a force sensor. The charging cradle 100 may transfer a signal corresponding to the received user's input to the processor 180. The processor 180 may recognize the matched device corresponding to the transferred signal. The processor 180 transmits a signal for a connection to the recognized matched device to the earbud placed on the charging cradle 100 through the communication circuit and the first interface 161 inside the charging cradle 100.

At this point, the matched device corresponding to the received input may be selected from among index-assigned devices that are among connection-target devices registered with the earbud 200.

Therefore, the processor 180 of the charging cradle 100 operates to recognize an index matched to the signal corresponding to the received user's input, to transmit a control signal for connecting the earbud to a device connected to the recognized index, and to enable the placed earbud to ascertain (recognize) a target device to which the recognized index is assigned, among the already registered devices. That is, according to the present disclosure, the index-assigned device, among the devices registered with the earbud 200, is regarded as a connection control target.

To this end, a storage-capable region inside the earbud 200 may include index information for controlling a connection to a device that is a connection target, and information about a device to which each index is assigned.

For example, indexes in use for the earbud 200 may include Indexes 1 to 3. Indexes 1, 2, and 3 may be assigned to Esther's Mobile, Esther's TV, and Ester's Watch, respectively, as matched devices. At least one of the matched devices may be set to be directly connectable. For example, in a case where Index 3 is assigned to a direct connection device, a connection control signal may be transmitted to Esther's Watch corresponding to Index 3 by receiving a one-time input for direct connection.

In an embodiment, the charging cradle 100 may select the matched device using the technique of varying a matching index in a rotating manner, based on the input received in the input unit 120.

Specifically, in response to an increase in the number of times of touch input applied to the input module (for example, a hard/soft button, a touch sensor, a force sensor, or the like) of the input unit 120, the charging cradle 100 may change an index in a rotating manner and may determine as a final matched device a device connected to an index corresponding to the last input.

At this point, whether or not the matched device is a final matched device may be determined based on whether or not an additional input is applied before a predetermined time (for example, 1 to 1.5 seconds) elapses after an input is received.

At this point, a change of the index in a rotating manner refers to a change of the index by increasing the index with an increase in touch input and by returning to an initial state when the index is no longer present and then increasing the index. For example, when a touch input is applied to the input module of the input unit 120, the index may change in the following sequence: Index 1, Index 2, Index 3, Index 1, Index 2, and so forth.

In an embodiment, a starting index for rotation may be determined based on whether or not a device connected to the earbud placed on the charging cradle 100 is present and based on whether or not a device connected to the earbud is a device to which an index is assigned.

For example, in a case where the placed earbud is already connected to a device B and where Index 2 is assigned to the device B, a position of a starting index for connection control may be Index 3 (or Index 2). In contrast, for example, in a case where a device connected to the placed earbud is not currently present or where the placed earbud is connected to a device to which an index is not assigned, a position of a starting index for connection control may be Index 1.

In another embodiment, the charging cradle 100 may recognize an index mapped to a specific input received in the input unit 120 and may select as a matched device a device to which the mapped index is assigned. In this case, regardless of an order of the rotation, the placed earbud 200 may transmit a connection signal to the device connected to the index mapped to the specific input.

At this point, the specific input may include a direct connection request, and a specific index may be pre-mapped to every specific input. For example, a technique may be employed in which a first index is mapped to a first input module of the input unit 120 of the charging cradle 100 and a second index is mapped to a second input module may be employed. In addition, a technique may be employed in which the first Index is mapped to a first touch input applied to the input module of the input unit 120 and the second index is mapped to the second touch input that is different from the first touch input.

To this end, different indexes may be mapped to a plurality of different inputs, respectively, that are applied to the input module of the input unit 120 of the charging cradle 100, and any one of devices that are connected to the different indexes, respectively, may be selected as the matched device.

In an embodiment, in a case where the device already connected to the earbud is present, based on the reception of the control signal, the earbud may first transmit a wireless signal (hereinafter referred to as a ‘first wireless signal) for a disconnection from the already connected device, and then, after the disconnection, may transmit to the mapped device a wireless signal (hereinafter referred to as a ‘second wireless signal’) requesting a connection to a device, which is contained in the control signal.

When a control signal for device connection is wirelessly transmitted to the matched device through the earbud placed on the charging cradle 100, a connection between the earbud and the matched device is made based on a response signal received by the placed earbud from the matched device.

In response to this connection of the earbud to the matched device through the placed earbud, the charging cradle 100 may output an alert signal indicating a connected state of the earbud, which contains information about the connected device (S400).

At this point, containing the information about the connected device means that information associated with which device the earbud is connected to is provided to the user when the user is alerted to a state of the connection of the earbud to the matched device.

As an embodiment, the charging cradle 100 may display the state of the connection of the earbud 200 to the matched device through one of the plurality of LED modules, that is, the LED modules 151 and 152 included in the output unit 150 and may display information associated with the connected matched device through the other LED module. In addition, as another embodiment, the charging cradle 100 may display the connected state and the information associated with the connected matched device through any of the plurality of LED modules, that is, the LED modules 151 and 152 included in the charging cradle 100 and may display an attempt by the earbud to make a connection to the matched device through the other LED module. At this point, the display may be performed through any one of the following: lighting, a color (for example, R, G, or B), or a lighting pattern of the LED module. Accordingly, through the earbud placed on the charging cradle, the user can intuitively recognize which device is connected.

In addition, in another embodiment, the charging cradle 100 may display an attempt by the placed earbud 200 to make a connection to the matched device, a connected state, and information about the connected device through a display module of the output unit 150.

In addition, in another embodiment, the charging cradle may output an attempt by the placed earbud 200 to make a connection to the matched device, a connected state, and information about the connected device through the audio output unit (for example, a speaker or the like) of the output unit 150.

In this manner, without performing an operation on the earbud or a device a connection to which is intended, the charging cradle according to the present disclosure may connect the earbud to a device a connection to which is desired, through the placed earbud only by applying the user input to the charging cradle that is always carried by the user. Furthermore, the user can intuitively recognize which device is connected.

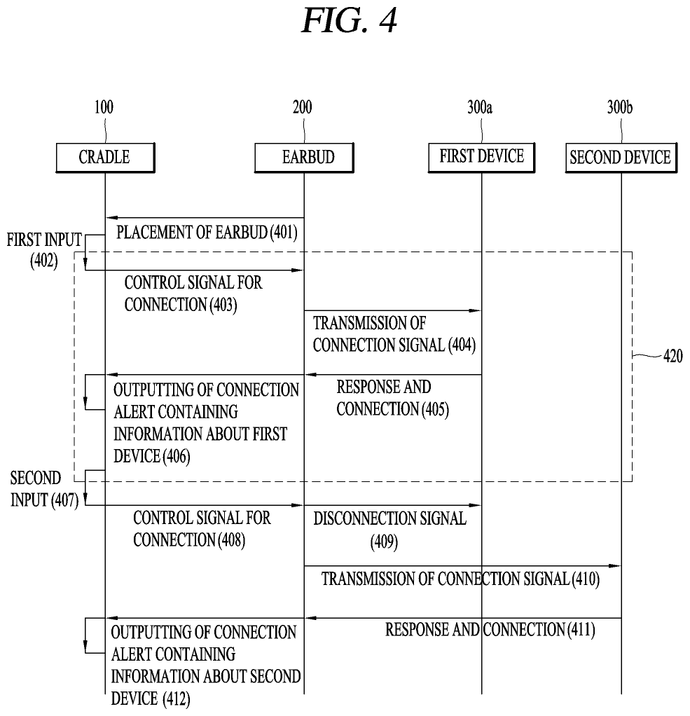

FIG. 4 is a flowchart that is referenced to describe a method of changing a device to which the earbud makes a connection using the charging cradle according to the embodiment of the present disclosure.

The earbud 200 may be embodied in such a manner as to make an automatic connection to any already connected one among the registered devices or to the last used device before being placed on the charging cradle 100. Considering this, FIG. 4 illustrates a method of making a connection to the first device, a disconnection therefrom, and a connection to the second device through the earbud 200 placed on the charging cradle 100.

When the earbud 200 is placed on the charging cradle 100 (S401), the charging cradle 100 may sense the placement of the earbud through an individual detection sensor included in the placement units 102a and 102b in which the earbud 200 is accommodated.

Accordingly, the charging cradle 100 may execute a connection mode for controlling the connection of the earbud to the device along with the charging of the placed earbud 200.

In an embodiment, when the connection mode is executed, the input unit 120 of the charging cradle 100 may be in an activated state in such a manner as to receive the user's input.

In another embodiment, when the connection mode is executed, an alert signal indicating a device currently connected to the earbud 200 placed on the charging cradle 100 may be output through the output unit 150. For example, when the connection mode is engaged after the earbud 200 placed on the charging cradle 100 is detected, a color indicating an index of a device, which is connected to the first LED module 151 of the output unit 150, may be displayed.

When a first input is received in the input module included in the input unit 120 (S402), the charging cradle 100 transfers a signal corresponding to the received first input to the processor 180. At this point, the first input may be, for example, a touch input of a preset type applied to the input module included in the input unit 120, or one or more successive touch inputs.

The processor 180 of the charging cradle 100 generates a connection signal for a connection between the earbud 200 and the first device 300a based on a signal corresponding to the first input. Then, the generated control signal is transferred to the earbud 200 placed on the charging cradle 100 (S403).

To this end, the charging cradle 100 may transmit the control signal to the communication module/interface of the earbud 200 through the communication circuit and the first interface 161 (in FIG. 2) inside the charging cradle 100. In this case, the control signal contains information about an index mapped to the first input. Accordingly, the earbud 200 placed on the charging cradle 100 may recognize a matched device corresponding to information about the received index.

The earbud 200 placed on the charging cradle 100 may transmit a connection signal to the first device 300a that is the matched device (S404). At this point, the first device 300a may be the last connected device or a preset direct connection device.

In addition, the first device 300a may be a device that is selected based on the first input, as one of connection-target devices that can be connected through an input to the charging cradle 100, among the devices registered with earbud 200.

The selected device may be determined based on a device currently connected to the earbud 200. For example, in a state where a pair of the earbuds 200 is placed on the charging cradle 100, when a button provided on the input unit 120 of the charging cradle 100 is once pushed down, a connection signal is transmitted to a device that has the next index after an index of the device currently connected to the earbud 200. In a case where a device currently connected to the earbud 200 is not present, when the button provided on the input unit 120 of the charging cradle 100 is once pushed down, a connection signal is transmitted to a device having Index 1.

The first device 300a may receive a connection signal of the earbud 200 and may transmit to the earbud 200 a response to the connection signal and a connection signal (S405). The earbud 200 transmits a signal alerting that a connection to the first device 300a is established, to the charging cradle 100 through the first interface 161 and thus enables the processor 180 of the charging cradle 100 to control the output unit 150.

Specifically, the output unit 150 of the charging cradle 100 may output a connection alert signal containing information about the first device 300a connected to the earbud 200 (S406).

At this point, the information about the device is provided as visual or audio data indicating an index assigned (allocated) to the device. For example, the information about the device may be one of the following: an LED color, preset signal sound, preset voice, predetermined text, a predetermined symbol, or the like.

Subsequently, (while the connection mode is maintained) an additional input, for example, a second input, may be received in the input unit 120 of the charging cradle 100 (S407).

At this point, the second input (in S407) may be a touch input that is the same type as, or a different type than, the first input (in S402). For example, the first input may be a single touch input, and a second input may be successive single touch inputs. In addition, the second input may be a touch input that is applied to an input module having a different position than the above-described first input.

In FIG. 4, in a case where the second input (in S407) is received in the charging cradle 100 within a predetermined time (for example, 1 to 1.5 seconds) after the first input (in S402) is applied, steps 403, 404, 405, and 406 included in Block 420 may be omitted. Accordingly, each time an input is received during the connection mode of the charging cradle 100, a connection to a device and a disconnection therefrom do not need to be repeated. That is, the earbud may be immediately connected to a desired device by successively performing the touch input without repeating unnecessary connection switching.

During the connection mode, in a state where the earbud 200 is connected, in this manner, to the first device 300a, in response to the reception of the user's input, for example, the second input, a first control signal for making a disconnection from the first device 300a and a second control signal for making a connection to the second device 300b matched to the user's input (the second input) are transmitted to the placed earbud 200.

At this point, the second device matched to the user's input may be a device connected to the earbud 200, that is, a device, having the next index after an index of the first device 200a, or a direct connection device. At this point, when the first device is assumed to be a device to which an index is not assigned, the second device may be a device to which Index 1 is assigned.

Subsequently, the earbud 200 transmits a disconnection signal corresponding to the received first control signal to the first device 300a (S409). Subsequently, the earbud 200 transmits a connection signal corresponding to the received second control signal to the second device 300b (S410).

When the response and the connection signal are received in the earbud 200 from the second device 300b (S411), the earbud 200 transmits to the charging cradle 100 a signal alerting that a connection to the second device is established. Then, the charging cradle 100 outputs to the output unit 150 a connection alert containing information about the second device 300b (S412). For example, the charging cradle 100 may display on the LED module a color indicating an index of the second device, may output through the audio output unit (speaker) preset signal sound or voice indicating the second device/index of the second device, or may display visual information, such as text, an image, or a symbol, that indicates the second device/index of the second device through the display module.

Examples of a method of displaying on the charging cradle 100 a connection of the earbud placed on the charging cradle to a device based on the user's input applied to the charging cradle 100 are described. As described above, an alert indicating that the connection of the earbud to the device is established may contain information (for example, an index assigned (allocated) to the device) about the connected device. The alert may be visual or audio information and may be output through the LED module, the display module, and the audio output unit (for example, a speaker).

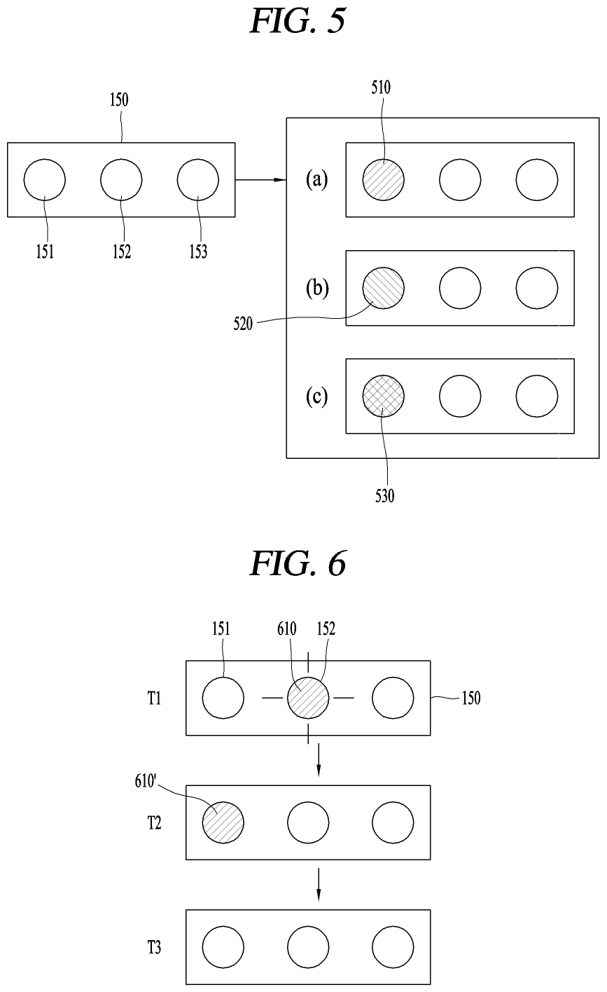

FIGS. 5, 6, and 7 illustrate examples, respectively, in which an alert output associated with the connection of the earbud to the device in the charging cradle according to the embodiment of the present disclosure is displayed through the LED module.

First, referring to FIG. 5, the output unit 150 of the charging cradle 100 according to the present disclosure may include the first and second LED modules 151 and 152 for display associated with the connection of the earbud to the device and a third LED module 153 for display associated with the charging of the earbud.

The first, second, and third LED modules 151, 152, and 153 may be connected to the processor 180 of the charging cradle 100 through at least one circuit inside the charging cradle, and may be controlled to be turned on/off in such a manner as to have different colors and lighting patterns according to a signal received through the processor 180.

For example, (a) illustrates that a first color display (for example, red) 510 on the first LED module indicates that the earbud placed on the charging cradle 100 is connected to the device having the first index. In addition, (b) illustrates that a second color display (for example, green) 520 on the first LED module indicates that the earbud placed on the charging cradle 100 is connected to the device having the second index. Moreover, (c) illustrates that a third color display (for example, blue) 530 on the first LED module indicates that the earbud placed on the charging cradle 100 is connected to the device having a third index.

Although not illustrated, in another embodiment, a position of the LED module that indicates each index may differ. In addition, the technique of indicating each index may be through a light pattern instead of an individual color display.

FIG. 6 illustrates that a connection between the earbud 200 and the device is displayed on the charging cradle 100 in the order of times T1, T2, and T3.

A first point T1 in time corresponds to a duration during which a request is made to the matched device through the earbud 200 placed on the charging cradle 100, that is, corresponds to a connection attempt section.

In the connection attempt section, a color display 610 (for example, red indicating the first index) that indicates an index of a device to which a connection is attempted is output to the second LED module 152 of the charging cradle. At this time, the color display 610 may flicker in such a manner that the user intuitively recognizes that an attempt is being made to make a connection.

A second point T2 in time corresponds to a connected-state section where a connection to the matched device is successfully made through the earbud 200 placed on the charging cradle 100.

In the connected-state section, the second LED module 152 is turned off, and a color display 610″ (for example, red indicating the first index) indicating the index of the connected device is output to the first LED module 151 At this point, the color display 610″ output to the first LED module 151 may continue for a predetermined time (for example, two to three seconds) starting from a point in time at which the earbud is connected to the matched device.

Subsequently, a third T3 in time corresponds to a section where a process of the connection between the matched device and the earbud through the earbud 200 placed on the charging cradle 100 is terminated, that is, corresponds to a control termination section. In the control termination section, the first and second LED modules 151 and 152 of the charging cradle are both in a turned-off state.

In the connected-state section at the second point T2 in time, in a case where the earbud and the matched device are disconnected from each other, for example, due to a network access problem or the like, returning to the connection attempt section at the first point T1 in time may take place without an additional input, and an attempt may be made again to make a connection to the matched device. Accordingly, the flickering color display 610 may be output back to the second LED module 152.

In the connection attempt section at the first point T1 in time, in a case where the connection between the earbud and the matched device fails, a display alerting that the connection has failed may be output and switching to the control termination section may take place. At this time, the display alerting that the connection has failed may appear on the third LED module or may appear in a different color pattern on any one of the first and second LED modules 151 and 152.

FIG. 7 illustrates that, in a case where a device to which the earbud 200 is intended to be connected is changed in the meantime, the connection at the charging cradle 100 is displayed in the order of times T1, T2, and T3.

In the connection attempt section T1, a color display 710 (for example, green indicating the second index) indicating an index of the first device to which a connection is being attempted may be output in a flickering manner to the second LED module 152 of the charging cradle 100.

Subsequently, when a request is made to attempt a connection to a different device due to the user's additional input or similar action, an attempt to make a connection to the above-described first device is interrupted. Subsequently, in the sustained connection attempt section T2, a different color display 720 (for example, blue indicating the third index) indicating an index of a different device to which a connection is being made, that is, the index of the second device, may be output in a flickering manner on the second module 152 of the charging cradle 100.

When the user does not make an additional request and the connection between the earbud and the second device is successfully made, switching to the connected-state section T3 takes place, and a color display 720′ indicating the index of the connected second device continues for a predetermined time on the first LED module 151 of the charging cradle 100.

Although not illustrated, in an embodiment, when a currently connected device is detected as being present at a point in time when the earbud 200 is sensed as being placed on the placement units 102a and 102b of the charging cradle, the processor 180 of the charging cradle 100 may control the first LED module to be in a turned-on state and may output to the first module a designated color display (for example, any one of R, G, and B) indicating an index assigned to the currently connected device.

In this manner, according to the present disclosure, when a connected device is present at a point in time when the earbud is placed on the charging cradle 100, the presence of the connected device is displayed on the LED module of the charging cradle. In addition, in a case where an attempt is being made to make a connection to a device through the placed earbud or where a connection to a device is successfully made, this state, containing information about the device may be displayed on the LED module of the charging cradle, and thus the user can immediately visually check both the connected device and a connected state thereof.

A method of controlling a connection to a device using only one placed earbud is described in detail below. The method applies in a case where only one of the pair of the earbuds 200 is placed on the charging cradle 100 and where the other one is worn on the user's ear and used or is positioned in proximity to the charging cradle 100.

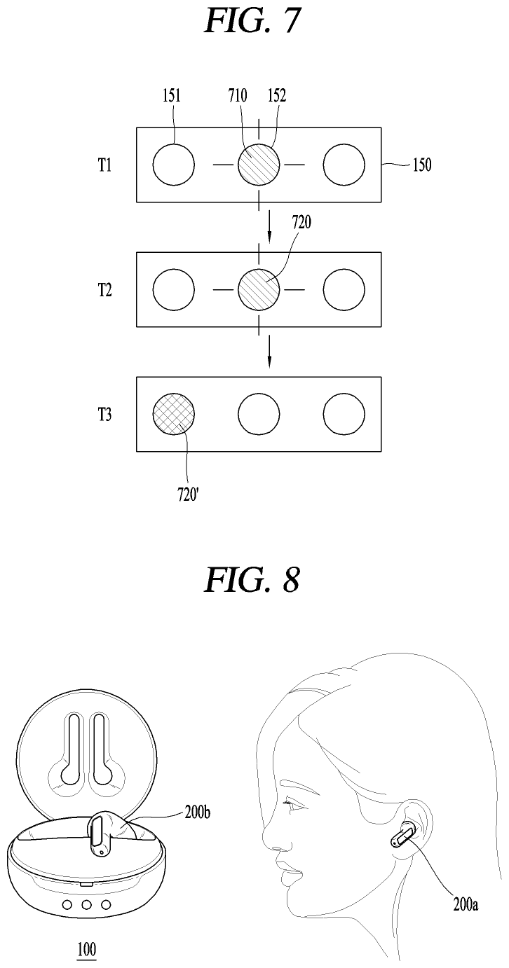

FIG. 8 is a view illustrating the charging cradle on which only one of the pair of the earbuds according to the embodiment of the present disclosure is placed.

The charging cradle 100 according to the present disclosure, as described above, includes the pair of the placement units 102a and 102b for accommodating the pair of the earbuds, respectively, and a sensor for individually detecting the earbud is provided to each of the pair of the placement units 102a and 102b.

According to the present disclosure, in a case where any one of the earbuds 200 is placed on the charging cradle 100, regardless of whether the placed earbud is for the left or right ear, the earbud (or the earbud in use) that is not placed may serve as the primary earbud. Therefore, through the earbud (or the earbud in use) that is not placed on the charging cradle 100, the user may receive and output audio associated with the connected device and may perform preset functional control.

For example, although the earbud 200b placed on the charging cradle 100 was originally used as the primary earbud in FIG. 8, at a point in time when the earbud 200b is placed on the charging cradle 100, the other earbud 200a serves as the primary earbud. Accordingly, an input associated with a control function may be applied through the other earbud 200a, and charging may be performed on the placed earbud 200b. This results from applying the same IP to the pair of the earbuds in such a manner that the earbud automatically serves as the primary earbud even in a case where only one earbud is used.

However, a function for making a connection to a different device is still performed by executing an earbud application on a terminal. Although the input module of the earbud is assumed to be used, a malfunctioning rate is significantly high due to the size limitation of the earbud.

For this reason, according to the present disclosure, in a state where only one earbud is placed on the charging cradle 100 and the other earbud is positioned nearby or in use, a method of controlling a connection to the above-described device and a method of expanded control are described in detail.

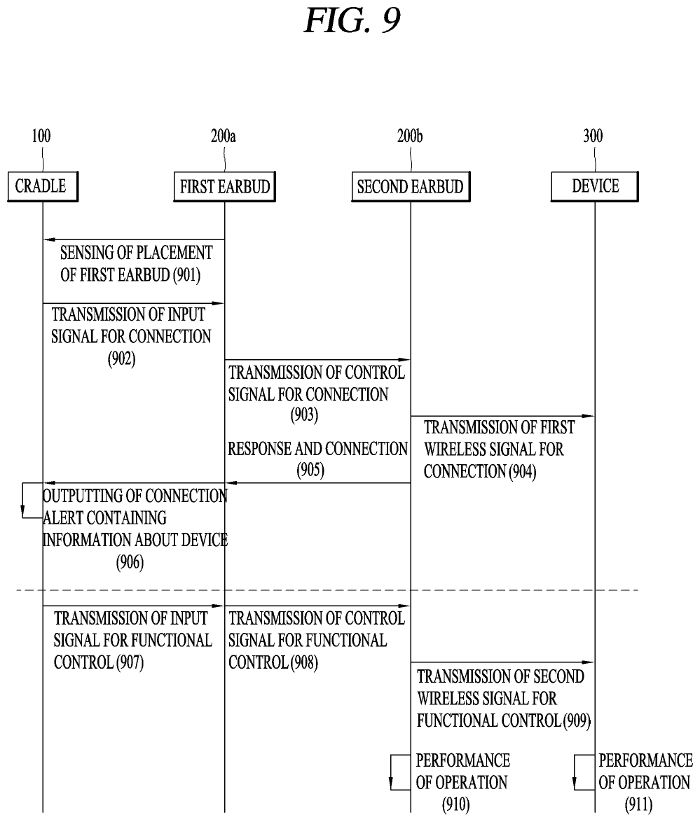

FIG. 9 illustrates both a method (S901 to S906) of performing connection control and a method (S901 and S907 to S911) of performing expanded functional control in a state where only the first earbud 200a of the pair of the earbuds is placed on the charging cradle 100.

First, the method of performing connection control using the first earbud 200a placed on the charging cradle 100 is as follows.

In a case where only the first earbud 200a is placed on the charging cradle 100, the charging cradle 100 may individually detect the placement of the first earbud 200a through the sensor included in the placement unit. When the placement of the first earbud is sensed (S901), the charging cradle 100 may not only start charging, but also execute the connection mode for the device connection. Subsequently, when an input signal for the device connection is received through the input unit 120 of the charging cradle 100, the input signal is transmitted to the first earbud 200a through the communication circuit and the first interface 161 inside the charging cradle 100 (S902). The control signal for connection is converted into a ‘wireless signal’ and is transmitted to the second earbud 200b, which is not placed, from the first earbud 200a (S903). In a case where the control signal for connection is received in this manner in the second earbud 200b, guidance voice or preset signal sound may be output through the output module of the second earbud 200b. The second earbud 200b that wirelessly communicates with the first earbud 200a transmits a first wireless signal for connection, to the device 300 matched to an index contained in the control signal (S904). When a response to the first wireless signal is transmitted to the second earbud 200b from the device 300, the second earbud 200b transmits a wireless signal corresponding to the response and connection, to the first earbud 200a placed on the charging cradle 100 (S905). Then, the first earbud 200a transmits a connection alert to the charging cradle 100, and the charging cradle 100 outputs the connection alert containing information about the connected device 300 (S906).

Next, the method of performing expanded functional control using the first earbud 200a placed on the charging cradle 100 is as follows.

First, when the placement of the first earbud is sensed (S901), the charging cradle 100 may subsequently execute an operational mode that can perform input for control of a function performable in a different earbud in use, that is, in the second earbud 200b.

The operational mode can be understood as being included in the above-described connection mode. Therefore, the user's input for connection control and the user's input for expanded functional control may be distinguished by using different input techniques or different keys with respect to the charging cradle 100. However, the operational mode, unlike the above-described connection mode, requires an additional starting condition: a connected device is present and at least one earbud is in use (or fits in the user's ear).

In the operational mode, an input signal for functional control, which is generated based on an input received through the input unit 120 of the charging cradle 100, is transmitted to the placed first earbud 200a (S907).

At this point, the input signal for the functional control may control calls to and from the connected device or may contain setting control such as active noise cancellation (ANC) mode setting, equalizer (EQ) mode (for changing sound quality) changing, and sound-source reproduction state changing. In addition, a controllable function corresponding to the input signal may be pre-mapped to a specific input module included in the input unit 120 of the charging cradle 100, or a specific function may be pre-mapped to every specific input technique. In an embodiment, a signal or voice, indicating a function that is selected based on the input signal, may be output to the charging cradle 100 or the earbud.

The input signal for this functional control is transmitted in the form of a wireless signal from the first earbud 200a back to the second earbud 200b (S908). Then, the input signal is wirelessly transmitted from the second earbud 200b, which serves as the primary earbud, to the connected device 300 (S909).

Accordingly, in the second earbud 200b, a function corresponding to the input signal is performed, and thus specific operations (for example, active noise cancellation (ANC) mode setting, call control for connection, call control for termination, and the like) are performed (S910). Likewise, in the connected device 300, the function corresponding to the input signal may also be performed, and accordingly, corresponding operations (for example, an ANC mode setting display, and a call control result display) may be performed (S911).

As described above, according to the present disclosure, the charging cradle 100, which is always carried, may be used as a controller for functionally controlling an earbud in use or a device connected to the earbud. Consequently, an erroneous operation due to the size limitation of the earbud can be prevented, thereby eliminating the resulting inconvenience.

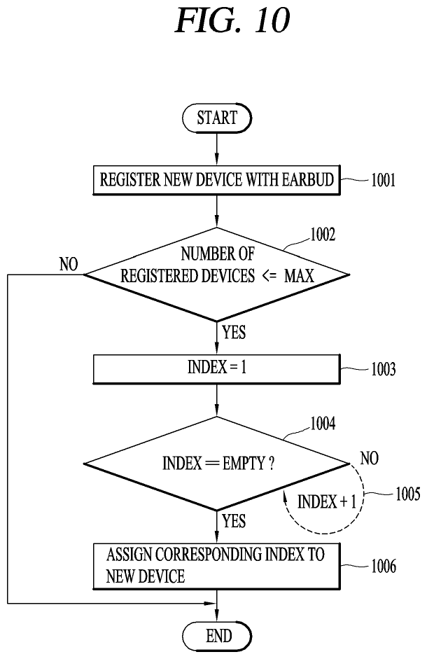

FIG. 10 illustrates a method of assigning an index to a device according to the embodiment of the present disclosure by executing an earbud application pre-installed on a terminal or similar device.

First, after the earbud application is executed, when a connection device registration step is entered, an operation for registering a new device with the earbud starts (S1001).

Next, it is determined whether or not the number of registered devices to which indexes, respectively, are currently assigned is at or below a maximum value MAX (S1002). That is, there is a limitation to the maximum number of the devices to which indexes, respectively, are assigned. According to the present disclosure, three indexes are described as being maximally mapped to the input unit 120 of the charging cradle 100. However, the maximum value MAX may be preset to two or fewer indexes or four or more indexes.

In a case where the number of the registered devices to which indexes, respectively, are assigned exceeds the maximum value MAX, the process is ended. At this time, the device that is connected to at least one index may be unset (deleted), and a current device may be added to a connection-target device group in a manner that is connected to such an index.

When the number of the registered devices to which indexes, respectively, are assigned is at or below the maximum value MAX, Index ‘1’ is assigned to a device that is currently intended to be registered (S1003). In a case where the index is empty (that is, in a case where there is no device that is connected to the index), an index that is assigned to the new device is fixed. That is, registration as the device that is connected to Index ‘1’ takes place. In contrast, in a case where the index is not empty (that is, when there is a device that is connected to the index), an index is incremented by one, and then it is determined whether or not the index (that is, Index ‘2’) is empty. As a result, an index is incremented by one, or registration as the device that is connected to Index ‘2’ takes place.

According to an embodiment, in a case where a plurality of new devices are registered on the earbud application, the device registration and the index assignment are performed sequentially.

In a case where the device to which an index is assigned in this manner is added, this event is received through the earbud placed on the charging cradle 100. In the case where the device to which an index is assigned in this manner is added, the charging cradle 100 may output to the output unit 150 an alert signal (for example, preset signal sound, alert voice, LED module lighting, or the like) corresponding to the event.

A device having an index mapped to the input unit 120 of the charging cradle 100 may be changed or deleted by executing the above-described earbud application.

In addition, in an embodiment, an expansion control function to be mapped to the input unit 120 of the charging cradle 100 may be set from a setting screen that appears by executing the above-described earbud application, in a state where only one earbud is placed.

As described above, according to the embodiments of the present disclosure, the connection of the earbud can be intuitively controlled more quickly using the charging cradle that is always carried by the user, without requiring any operation on the earbud, where erroneous operations occur frequently or the counterpart device. In addition, a device that is currently connected to the earbud can be quickly checked through the charging cradle, and a connected state of a newly connected device and information about the connected device can be intuitively recognized through the placed earbud. Moreover, various control functions that are further expanded, as well as device connection control, can be performed using mutual wireless communication between the pair of the earbuds while one earbud is placed and the other earbud is worn and used.

The present invention can be implemented as computer-readable codes (applications or software) in a program-recorded medium. The method of controlling the autonomous vehicle can be realized by a code stored in a memory or the like.

The computer-readable media may include all kinds of recording apparatuses in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The computer may include the processor or the controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

1. An earbud charging cradle configured to receive an earbud capable of wireless communication, the earbud charging cradle comprising:
a placement unit configured to accommodate the earbud, and configured to charge the earbud;
a sensing unit configured to sense placement of the earbud on the placement unit;
a communication unit configured to perform communication with the earbud placed on the placement unit;
an input unit configured to receive a user's input;
an output unit configured to output an alert associated with a connected device; and
a processor configured to execute a connection mode that controls a connection to a device when the placement of the earbud on the placement unit is sensed by the sensing unit,
wherein, during the connection mode, the processor transmits to the earbud a control signal through the communication unit for connecting the earbud to a matched device corresponding to an input received in the input unit and, in response to a connection of the earbud to the matched device through the earbud, outputs to the output unit an alert signal indicating a connected state of the earbud, which contains information about the connected device.

2. The earbud charging cradle of claim 1, wherein the matched device corresponding to the received input is selected from among index-assigned devices that are among connection-target devices registered with the earbud.

3. The earbud charging cradle of claim 2, wherein the received input, which corresponds to a touch input or successive touch inputs applied to the input unit, causes an index of the index-assigned devices to vary, in a rotating manner, with an increase in a number of times of the touch input, and a device among the index-assigned devices is selected as the matched device based on the received input.

4. The earbud charging cradle of claim 2, wherein the received input corresponds to any one of a plurality of different inputs that are applied to the input unit,
wherein different indexes are mapped to the plurality of different inputs, respectively, and
wherein any one of the index-assigned devices, respectively, is selected as the matched device based on the received input.

5. The earbud charging cradle of claim 1, wherein during the connection mode, in response to reception of a first input in a state where the earbud is connected to a first device, the processor transmits to the earbud a first control signal for disconnecting from the first device and a second control signal for connecting to a second device matched to the first input.

6. The earbud charging cradle of claim 1, wherein the output unit comprises:
a plurality of light-emitting diode (LED) modules, and
wherein, in response to the connection of the earbud to the matched device through the earbud, the processor controls a first LED module to be in a turned-on state and controls the output unit to output a display indicating the connected matched device while the first LED module is in the turned-on state.

7. The earbud charging cradle of claim 6, wherein, in response to the transmission of the control signal for connecting the earbud to the matched device to the earbud, the processor controls a second LED module to be in a turned-on state and controls the output unit to display a display indicating the matched device to which a connection is being attempted, while the second LED is in the turned-on state.

8. The earbud charging cradle of claim 7, wherein a display indicating the matched device, which is output to the first and second LED modules, is a color-designated display indicating an index assigned to the matched device.

9. The earbud charging cradle of claim 8, wherein, when a currently connected device is detected as being present when the earbud is placed on the placement unit, the processor controls the first LED module to be in the turned-on state and transmits a signal to the output unit to display a designated color indicating an index assigned to the currently connected device on the first LED module.

10. The earbud charging cradle of claim 1, further comprising a pair of earbuds,
wherein the sensing unit comprises:
a plurality of sensors configured to sense the placement of the pair of the earbuds, respectively, that are capable of wirelessly communicating with each other, and
wherein, when placement of a first earbud is sensed through a first sensor of the plurality of sensors and when placement of a second earbud is not sensed through a second sensor of the plurality of sensors, during the connection mode, the processor controls the control signal such that the indicated matched device from the input received in the input unit is transmitted from the first earbud to the second earbud and that, in response to a connection to the matched device through the second earbud, the alert signal is output based on a connection response signal received in the first earbud from the second earbud.

11. The earbud charging cradle of claim 1, wherein in a state where placement of a first earbud is sensed through a first sensor and where a second earbud is connected to the matched device without placement of the second earbud being sensed, in response to reception of an input for functional control, which is received in the input unit, the processor enables a functional control signal, corresponding to the received input, to be transmitted from the first earbud to the second earbud and enables the second earbud and the matched device to perform operations, respectively, that correspond to the functional control signal.

12. An earbud connection method that uses a cradle on which at least one earbud is configured to be placed and charged, the earbud connection method comprising:
sensing placement of the at least one earbud on the cradle;
executing a connection mode that controls a connection to a device;
transmitting to the at least one earbud a control signal for connecting the at least one earbud to a matched device corresponding to an input received in the cradle; and
outputting an alert signal indicating a connected state of the at least one earbud, which contains information about the matched device.

13. The earbud connection method of claim 12, further comprising, after the transmitting to the at least one earbud the control signal:
enabling a first light-emitting diode (LED) module included in the cradle to be in a turned-on state, and
displaying on the first LED module a color indicating an index corresponding to the matched device for which a connection between the at least one earbud and the matched device is intended.

14. The earbud connection method of claim 13, wherein the outputting the alert signal comprises:
enabling a second LED module, different from the first LED module, which is included in the cradle, to be in a turned-on state, and
displaying on the second LED module a color indicating the index corresponding to the connected matched device.

15. The earbud connection method of claim 12, wherein the sensing the placement of the at least one earbud includes sensing through a first sensor that a first earbud is placed and sensing through a second sensor that a second earbud is not placed, and
wherein the transmitting to the at least one earbud the control signal comprises:
making a connection to the matched device through the second earbud by transmitting the control signal from the first earbud to the second earbud.

16. An earbud connection system comprising:
a pair of earbuds configured to provide associated audio by performing wireless communication with a device; and
a charging cradle on which the pair of earbuds are configured to be placed and charged,
wherein the charging cradle executes a connection mode that controls a connection to the device when a placement of one earbud of the pair of earbuds is sensed, and transmits to the one earbud a control signal for connecting an other earbud to a matched device corresponding to a received input, and
wherein the other earbud transmits to the matched device a connection signal corresponding to the control signal, determines a connection based on a response signal received from the matched device, transmits to the charging cradle a signal corresponding to the determined connection, and outputs an alert signal indicating a connected state of the other earbud, which contains information about the matched device to which the charging cradle is connected.

17. The earbud connection system of claim 16, wherein the alert signal is displayed on a display including a plurality of light-emitting diodes (LED) modules, and
wherein a color of at least one LED module of the plurality of LED modules indicates the matched device from among a plurality of devices.

18. The earbud connection system of claim 17, wherein when the other earbud is attempting to connect to the matched device, an LED module of the plurality of LED modules intermittently flashes to indicate that the connection to the matched device has not yet been established.

19. The earbud connection system of claim 16, wherein the charging cradle includes an input unit configured to receive the received input, and
wherein a user inputs the input into the input unit to indicate which device from a plurality of devices is the matched device.

20. The earbud connection system of claim 16, wherein a most recently used device by a user is the matched device.
